(19) United States
(12) Patent Application Publication
(10) Pub. No.: US 2024/0406066 A1
(43) Pub. Date: Dec. 5, 2024

(54) NETWORK CONFIGURATION DEVICE, INFORMATION SYSTEM, NETWORK CONFIGURATION METHOD, AND RECORDING MEDIUM

(71) Applicant: NEC Corporation, Minato-ku, Tokyo (JP)

(72) Inventors: Yoshiaki SAKAE, Tokyo (JP); Jun Nishioka, Tokyo (JP)

(73) Assignee: NEC Corporation, Minato-ku, Tokyo (JP)

(21) Appl. No.: 18/698,464

(22) PCT Filed: Nov. 12, 2021
(86) PCT No.: PCT/JP2021/041670

§ 371 Date: Apr. 4, 2024

(51) Int. Cl. H04L 41/0866; H04L 41/0895; H04L 43/045

(52) U.S. Cl. CPC H04L 41/0866; H04L 41/0895; H04L 43/045

(57) ABSTRACT

A network configuration device according to the present disclosure comprises: an authenticity requirement information acquiring means that acquires authenticity requirement information related to the requirement of authenticity with respect to a communication service; an equipment information acquiring means that acquires equipment information in which the configuration and risk related to network equipment to be connected to a physical network are visualized; an authenticity determination means that determines the authenticity of the network equipment on the basis of the acquired equipment information; and a network configuration means that configures a virtual network on the physical network on the basis of the authenticity requirement information and the determination result of the authenticity of the network equipment.

### TECHNICAL FIELD

The present disclosure relates to a network configuration device, an information system, a network configuration method, and a recording medium.

### BACKGROUND ART

Communication services in response to various requests from users, such as use of a high-speed line and use of a high-quality line without interruption of data communication, are operated in a network. For this reason, there is a technology called a network slice that selects and operates a slice for each service in a plurality of virtual networks in the network.

For example, PTL 1 discloses a network service management device that determines a resource to which a function matching a requirement of a virtual network constituting a network service is allocated.

### CITATION LIST

### Patent Literature

PTL 1: JP 2020-36105 A

### SUMMARY OF INVENTION

### Technical Problem

A network with high reliability and high performance increases the cost of construction and operation, but may not necessarily have high reliability and high performance depending on the application of communication. The invention described in PTL 1 does not constitute a network service in consideration of the cost of communication services.

An object of the present disclosure is to provide a network configuration device capable of configuring a network in consideration of cost of a communication service.

### Solution to Problem

A network configuration device according to an aspect of the present disclosure includes: an authenticity requirement information acquiring means that acquires authenticity requirement information related to the requirement of authenticity with respect to a communication service; an equipment information acquiring means that acquires equipment information from an equipment information storage device; an authenticity determination means that determines the authenticity of the network equipment based on the acquired equipment information; and a network configuration means that configures a virtual network on the physical network based on the authenticity requirement information and the determination result of authenticity of the network equipment.

An information system according to an aspect of the present disclosure includes: a network configuration device; a service slice management device that manages and controls the network configuration device; and an equipment information storage device that stores equipment information in which a configuration and a risk regarding a network equipment connected to a physical network are visualized, in which the network configuration device includes: an authenticity requirement information acquiring means that acquires authenticity requirement information related to requirement of authenticity with respect to a communication service; an equipment information acquiring means that acquires the equipment information from the equipment information storage device; an authenticity determination means that determines authenticity of the network equipment based on the acquired equipment information; and a network configuration means that configures a virtual network on the physical network based on the authenticity requirement information and a determination result of authenticity of the network equipment.

A network configuration method according to an aspect of the present disclosure includes: acquiring authenticity requirement information related to requirement of authenticity with respect to a communication service; acquiring equipment information visualizing a configuration and a risk regarding network equipment connected to a network; determining authenticity of the network equipment based on the acquired equipment information; and configuring a virtual network on the physical network based on the authenticity requirement information and a determination result of authenticity of the network equipment.

A recording medium according to an aspect of the present disclosure stores a program causing a computer to execute: acquiring authenticity requirement information related to requirement of authenticity with respect to a communication service; acquiring equipment information visualizing a configuration and a risk regarding network equipment connected to a network; determining authenticity of the network equipment based on the acquired equipment information; and configuring a virtual network on the physical network based on the authenticity requirement information and a determination result of authenticity of the network equipment.

### Advantageous Effects of Invention

An example of an effect of the present disclosure is to provide a network configuration device capable of configuring a virtual network in consideration of the cost of communication services.

### BRIEF DESCRIPTION OF DRAWINGS

FIG. 1 is a block diagram illustrating a configuration of a network configuration device according to a first example embodiment.

FIG. 2 is a diagram illustrating a hardware configuration in which a network configuration device according to the first example embodiment is implemented by a computer device and its peripheral devices.

FIG. 3 is a flowchart illustrating a network configuration according to the first example embodiment.

FIG. 4 is a block diagram illustrating a configuration of a network configuration device according to a modification of the first example embodiment.

FIG. 5 is a block diagram illustrating a configuration of a network configuration device according to a second example embodiment.

FIG. 6 is a flowchart illustrating an operation of a network configuration according to the second example embodiment.

### EXAMPLE EMBODIMENT

Next, example embodiments will be described in detail with reference to the drawings.

### First Example Embodiment

A network configuration device 100 according to a first example embodiment is a device that configures a plurality of virtual networks (slices) including one physical network and performs network slicing for allocating functions necessary for communication services. The virtual network refers to a network in which physical resources are abstracted by software and can be logically grouped or divided and used.

The network slice is a technology of constructing a plurality of independent slices by software according to a requirement of a communication service end-to-end across domains while using network equipment such as a general-purpose server or a transport device in common. By arranging resources such as a data processing function and a storage in each slice using the network slice, it is possible to construct communication services having different requirements separately for each slice. The network configuration device 100 is implemented by, for example, a plurality of resource controllers that manage and control various devices for each domain (for example, radio access, transport and data center).

An information system 10 according to the present example embodiment includes a network configuration device 100, a service slice management device 200 that manages and controls the network configuration device 100, and an equipment information storage device 300 that stores equipment information of a network equipment connected to a network slice.

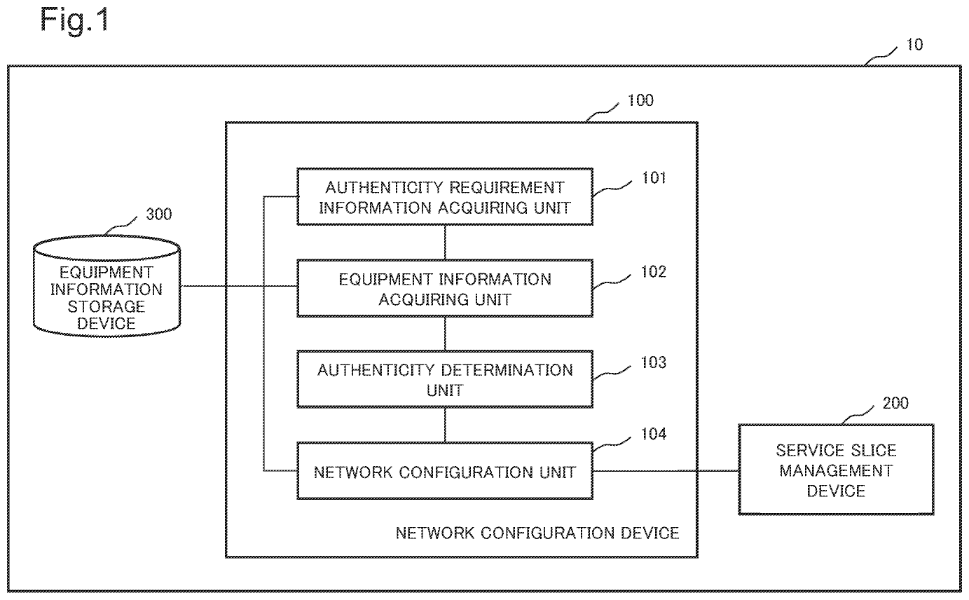

FIG. 1 is a block diagram illustrating a configuration of the network configuration device 100 according to the first example embodiment. Referring to FIG. 1, the network configuration device 100 includes an authenticity requirement information acquiring unit 101, an equipment information acquiring unit 102, an authenticity determination unit 103, and a network configuration unit 104. Hereinafter, the network configuration device 100 which is an essential configuration of the present example embodiment will be described in detail.

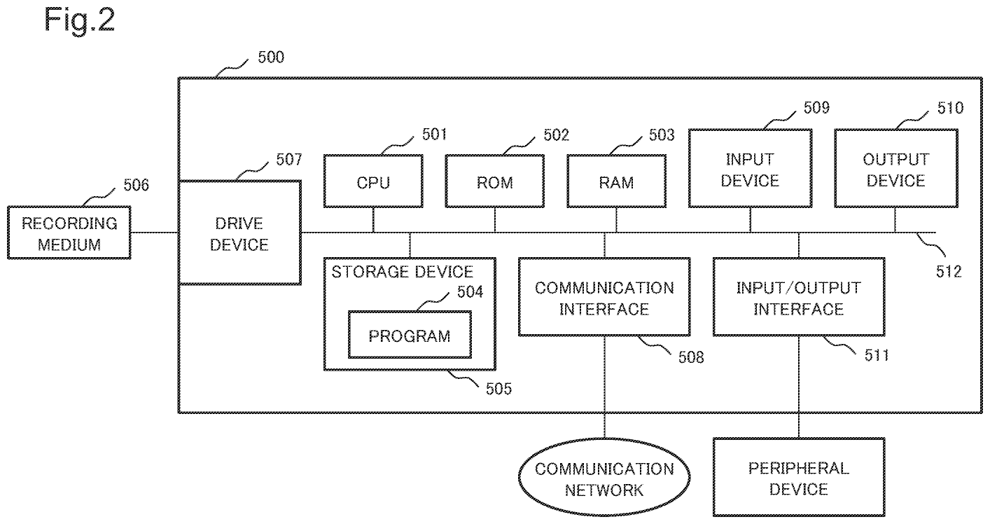

FIG. 2 is a diagram illustrating an example of a hardware configuration in which the network configuration device 100 according to the first example embodiment of the present disclosure is achieved by a computer device 500 including a processor. As illustrated in FIG. 2, the network configuration device 100 includes a memory such as a central processing unit (CPU) 501, a read only memory (ROM) 502, and a random access memory (RAM) 503, a storage device 505 such as a hard disk that stores a program 504, a communication interface (I/F) 508 for network connection, and an input/output interface 511 that inputs and outputs data. In the first example embodiment, the authenticity requirement information acquired by the authenticity requirement information acquiring unit 101 is input to the network configuration device 100 via the input/output interface 511, for example. The equipment information acquired by the equipment information acquiring unit 102 is input to the network configuration device 100 via the communication I/F.

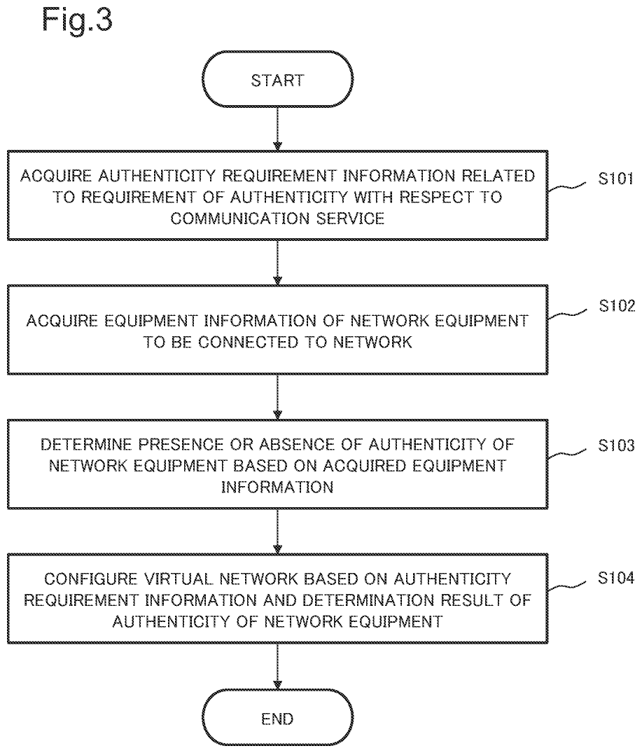

The CPU 501 operates the operating system to control the entire network configuration device 100 according to the first example embodiment of the present invention. The CPU 501 reads a program and data from a recording medium 506 mounted on, for example, a drive device 507 to a memory. The CPU 501 functions as the authenticity requirement information acquiring unit 101, the equipment information acquiring unit 102, the authenticity determination unit 103, the network configuration unit 104, and a part thereof in the first example embodiment, and executes processing or a command in the flowchart illustrated in FIG. 3 described later based on the program.

The recording medium 506 is, for example, an optical disk, a flexible disk, a magnetic optical disk, an external hard disk, a semiconductor memory, or the like. A part of the recording medium of the storage device is a non-volatile storage device, and records a program in the part. The program may be downloaded from an external computer (not illustrated) connected to a communication network.

An input device 509 is achieved by, for example, a mouse, a keyboard, a built-in key button, and the like, and is used for an input operation. The input device 509 is not limited to a mouse, a keyboard, and a built-in key button, and may be, for example, a touch panel. An output device 510 is achieved by, for example, a display, and is used to confirm an output.

As described above, the first example embodiment illustrated in FIG. 1 is implemented by the computer hardware illustrated in FIG. 2. However, the means for implementing each unit included in the network configuration device 100 of FIG. 1 is not limited to the configuration described above. The network configuration device 100 may be implemented by one physically coupled device, or may be implemented by a plurality of devices by connecting two or more physically separated devices in a wired or wireless manner. For example, the input device 509 and the output device 510 may be connected to the computer device 500 via a network. The network configuration device 100 according to the first example embodiment illustrated in FIG. 1 can be configured by cloud computing or the like.

In FIG. 1, the authenticity requirement information acquiring unit 101 is a means that acquires authenticity requirement information related to the requirement of authenticity with respect to a communication service. The authenticity requirement information is information regarding whether authenticity is required for the target communication service. In the present example embodiment, “authenticity is required” means that authenticity is required for all network equipment to be used. The authenticity of the network equipment to be used is required for the field that requires reliability of the communication service. Reliability of a communication service is particularly required in a field of handling highly confidential information. The field of handling highly confidential information is, for example, a space, defense, medical, financial, or the like. Examples of the highly confidential information include know-how such as design information and good or bad resin characteristics in a factory. On the other hand, low confidential information generally includes a game image and a video captured for video monitoring. For example, the authenticity requirement information acquiring unit 101 acquires the authenticity requirement information by receiving an input related to the requirement of the authenticity from the input device 509.

The equipment information acquiring unit 102 is a means that acquires equipment information in which a configuration and a risk regarding a network equipment connected to a network are visualized. The equipment information acquiring unit 102 acquires equipment information of each network equipment on the network connected to a plurality of resource controllers. The network equipment on the network may be singular or plural. In the present example embodiment, the equipment information is information necessary for determining the authenticity of the network equipment, and includes information with different types of configuration information, event information, and inspection information. The event information and the inspection information are information visualizing the risk of the network equipment. The equipment information acquiring unit 102 acquires the equipment information of the network equipment to be monitored from the equipment information storage device 300. Here, each piece of equipment information stored in the equipment information storage device 300 will be described. In the equipment information storage device 300, for example, the configuration information, the event information, and the inspection information are stored for each network equipment together with the time when the information is acquired.

The configuration information is, for example, hardware information and software information of the network equipment. The hardware information is manufacturer information, model numbers of chips, substrates, ports, and the like constituting hardware, identifiers assigned to hardware, and the like. The software information is manufacturer information, an operating system (OS) that processes hardware, a software name of a library, an application, or the like, version information of the software, a hash value, or the like. The hash value is a value calculated from data including software binaries and the like, and can be compared with a hash value distributed from a software manufacturer to confirm identity with the software distributed from the manufacturer. The configuration information is updated at a timing when the configuration information such as a software version upgrade timing is updated.

The event information is, for example, log information that has occurred in the network equipment. As the log information, for example, packet communication information such as a communication data amount, a communication error rate, or the number of times of packet retransmission of each network port connected to the network equipment is stored. The event information is updated at intervals of several seconds, for example.

The inspection information is information related to a result of inspection analysis based on the configuration information and the event information of the device to be monitored. In the inspection result, the result of the presence or absence of the authenticity of the equipment is stored in association with the time information. The inspection information is updated, for example, at each timing when the configuration such as version upgrade of the software of the network equipment is changed or at each timing when the event information greatly changes.

The authenticity determination unit 103 is a means that determines the authenticity of the network equipment based on the equipment information acquired by the equipment information acquiring unit 102. In the present example embodiment, authenticity is a state in which settings and the like of hardware information and software information of network equipment are not erased, falsified, replaced, or the like. The authenticity determination unit 103 first determines the authenticity of the network equipment using a known method for each piece of the configuration information, the event information, and the inspection information, and outputs authenticity individual information as a result of determining the authenticity.

For the configuration information, for example, the authenticity determination unit 103 determines whether there is authenticity based on a difference between the configuration information at the time when the system is delivered and the configuration information stored in the equipment information storage device 300. Regarding the event information, for example, the authenticity determination unit 103 determines whether the device has authenticity based on the obtained event information. The equipment information acquiring unit 102 determines whether there is authenticity of the inspection information based on, for example, an analysis result of the inspection and whether the inspection is performed.

Next, the authenticity determination unit 103 comprehensively determines the authenticity of the network equipment based on the authenticity individual information that is the determination result of authenticity of the configuration information, the event information, and the inspection information. The authenticity determination unit 103 outputs the authenticity information as the determination result of authenticity. The authenticity information is information indicating whether authenticity is secured, and may be indicated by a binary of presence or absence of authenticity. Alternatively, the authenticity information may be indicated by a numerical value (score) such as 0 to 100%.

For example, when the authenticity information is indicated by the presence or absence of authenticity, and in a case where there is authenticity in any of the configuration information, the event information, and the inspection information of the network equipment, the authenticity determination unit 103 determines that there is authenticity in the network equipment. In a case where none of the pieces of information in the equipment information of the network equipment is authentic, the authenticity determination unit 103 determines that the network equipment is not authentic. In a case where the equipment information of the network equipment includes information with authenticity and information without authenticity, the authenticity determination unit 103 determines that there is authenticity in accordance with the number of pieces of information determined to have authenticity and the type of information determined to have authenticity. For example, in a case where it is determined that there is no authenticity with respect to the configuration information, but it is determined that there is authenticity with respect to the event information and the inspection information, the authenticity determination unit 103 determines that there is authenticity. However, the authenticity determination method by the authenticity determination unit 103 is not limited thereto.

The network configuration unit 104 is a means that configures a virtual network based on the authenticity requirement information acquired by the authenticity requirement information acquiring unit 101 and the determination result of authenticity of the equipment determined by the authenticity determination unit 103. In a case where the information that the authenticity of the communication service is necessary is acquired from the authenticity requirement information acquiring unit 101, the network configuration unit 104 configures a virtual network so as to include only the network equipment determined to have authenticity by the authenticity determination unit 103. On the other hand, in a case where the information that the authenticity of the communication service is not necessary is acquired from the authenticity requirement information acquiring unit 101, the network configuration unit 104 configures a virtual network so as to include the network equipment determined to have no authenticity by the authenticity determination unit 103. In a case where the information that the authenticity of the communication service is not necessary is acquired from the authenticity requirement information acquiring unit 101, the network configuration unit 104 may configure a virtual network using only the network equipment determined to have no authenticity by the authenticity determination unit 103. The network configuration unit 104 transmits information on the network equipment constituting the virtual network to the service slice management device 200.

The operation of the network configuration device 100 configured as described above will be described with reference to the flowchart of FIG. 3.

FIG. 3 is a flowchart illustrating an outline of an operation of the network configuration device 100 according to the first example embodiment. The processing according to this flowchart may be executed based on program control by the processor described above.

As illustrated in FIG. 3, first, the authenticity requirement information acquiring unit 101 acquires the authenticity requirement information related to the requirement of the authenticity with respect to the communication service (step S101). Next, the equipment information acquiring unit 102 acquires equipment information of a network equipment connected to the network (step S102). Next, the authenticity determination unit 103 determines the authenticity of the network equipment based on the equipment information acquired by the equipment information acquiring unit 102 (step S103). Finally, the network configuration unit 104 configures a virtual network based on the authenticity requirement information acquired by the authenticity requirement information acquiring unit 101 and the determination result of authenticity determined by the authenticity determination unit 103 (step S104). Thus, the network configuration device 100 terminates the operation of the network configuration.

In the network configuration device 100 according to the present example embodiment, the network configuration unit 104 configures a virtual network based on the authenticity requirement information acquired by the authenticity requirement information acquiring unit 101 and the determination result of authenticity determined by the authenticity determination unit 103. As a result, for example, in a case of providing a communication service for which high reliability is not required, the network configuration device 100 can configure a virtual network without using a costly device for which authenticity is secured. As a result, the reliability and cost of the communication service can be balanced, and the network can be configured in consideration of the cost of the communication service.

### [Modification of First Example Embodiment]

Next, a modification of the first example embodiment of the present disclosure will be described in detail with reference to the drawings. Hereinafter, description of contents overlapping with the above description will be omitted to the extent that the description of the present example embodiment is not unclear.

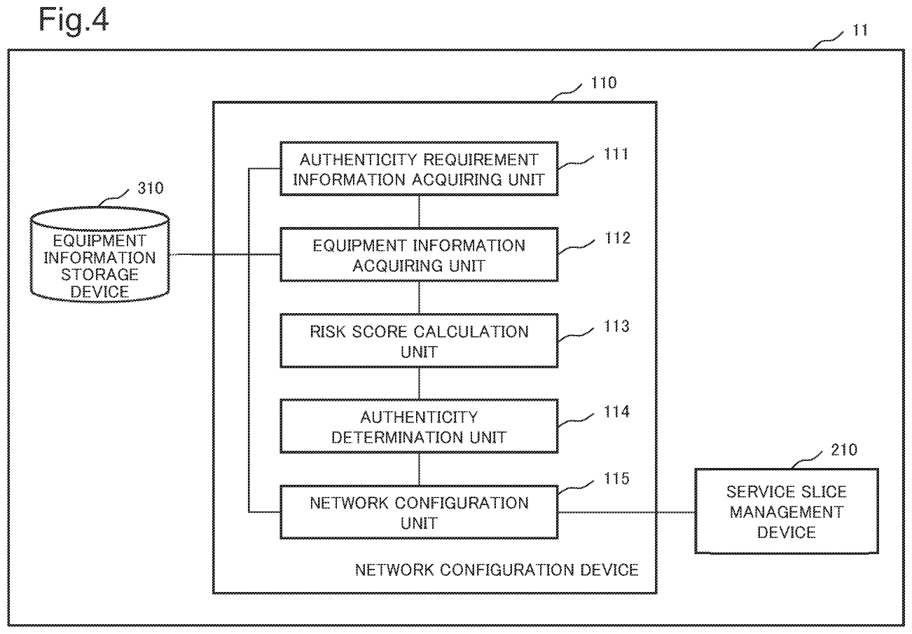

FIG. 4 is a block diagram illustrating a configuration of a network configuration device 110 according to a modification of the first example embodiment of the present disclosure. With reference to FIG. 4, the network configuration device 110 according to the modification of the first example embodiment will be described focusing on portions different from those of the network configuration device 100 according to the first example embodiment. The network configuration device 110 includes an authenticity requirement information acquiring unit 111, an equipment information acquiring unit 112, a risk score calculation unit 113, an authenticity determination unit 114, and a network configuration unit 115. That is, the present example embodiment is different from the first example embodiment in that the risk score calculation unit 113 is provided. Since the operations of the authenticity requirement information acquiring unit 111 and the equipment information acquiring unit 112 are similar to those of the authenticity requirement information acquiring unit 101 and the equipment information acquiring unit 102, the description thereof is herein omitted.

The risk score calculation unit 113 is a means that calculates a risk score that is a degree of authenticity based on the equipment information. The risk score calculation unit 113 calculates a risk score based on each piece of information of the device configuration information, the event information, and the inspection information. First, the risk score calculation unit 113 scores the authenticity of each piece of information by a known method based on the equipment information acquired by the equipment information acquiring unit 102. Specifically, for the configuration information, the risk score calculation unit 113 increases the score when the configuration information is close to the configuration information at the time of delivery, and decreases the score as the number of different portions increases. The risk score calculation unit 113 may score the configuration information of the software by comparing the configuration information with the configuration information at the time of update instead of the configuration information at the time of delivery. That is, the score is set to be high in a case of being close to the configuration information of the software at the time of update, and the score is set to be low as the number of different portions increases. In the case of event information, the risk score calculation unit 113 increases the score in a case where the event information is close to a normal value, and decreases the score as the different portions increase. The risk score calculation unit 113 scores the inspection information according to the inspection result.

The risk score calculation unit 113 scores the risk score based on various types of information of the configuration information, the event information, and the inspection information by the above-described method. Next, the risk score of the entire network equipment is calculated by adding the numerical values of the various types of authenticity information associated with the target network equipment using a method such as logical sum, arithmetic average, or summation. However, the calculation method by the risk score calculation unit 113 is not limited thereto. The risk score may be calculated using an artificial intelligence (AI) model generated based on a correlation between various types of authenticity information and an actual authenticity result. The risk score calculation unit 113 outputs the risk score of the device calculated in this manner to the authenticity determination unit 114.

The authenticity determination unit 114 determines the authenticity of the network equipment based on the risk score calculated by the risk score calculation unit 113. In a case where the calculated risk score is larger than a predetermined threshold, the authenticity determination unit 114 determines that there is authenticity. On the other hand, in a case where the calculated risk score is not larger than the predetermined threshold, the authenticity determination unit 114 determines that there is no authenticity. The threshold information is stored in the storage device 505, for example. The authenticity determination unit 114 outputs the determination result of authenticity to the network configuration unit 115.

The network configuration unit 115 configures a virtual network based on the authenticity requirement information acquired by the authenticity requirement information acquiring unit 111 and the determination result of authenticity of the equipment determined by the authenticity determination unit 114. A specific method of configuring a virtual network by the network configuration unit 115 is similar to that in the first example embodiment.

In a modification of the first example embodiment of the present disclosure, the authenticity determination unit 114 determines the authenticity of the network equipment based on the risk score calculated by the risk score calculation unit 113. As a result, the authenticity condition of the network equipment can be finely set.

In the present example embodiment and the modification of the present example embodiment, the authenticity requirement information acquiring unit 101 acquires the information regarding whether authenticity is required for the target communication service, as the authenticity requirement information related to the requirement of the authenticity with respect to the communication service. However, the authenticity requirement information acquiring unit 101 may acquire information regarding to what extent authenticity is required. In this case, the network configuration unit 104 configures a virtual network so as to include the network equipment determined to have authenticity or the network equipment determined to have no authenticity by the authenticity determination unit 103 according to the degree of authenticity requirement acquired by the authenticity requirement information acquiring unit 101.

In the present example embodiment, the authenticity determination unit 103 first determines the authenticity of the network equipment for each of the configuration information, the event information, and the inspection information by a known method, and comprehensively determines the authenticity of the network equipment based on the authenticity individual information that is the determination result of authenticity. However, the authenticity determination unit 103 may acquire each piece of authenticity individual information determined by the network equipment based on the various pieces of equipment information, and determine the authenticity of the network equipment based on each piece of the acquired authenticity individual information. In the modification of the present example embodiment, the risk score calculation unit 113 scores the authenticity of the various types of equipment information based on the equipment information. However, the network equipment may acquire information (authenticity individual information) scoring the authenticity of the various types of equipment information.

### Second Example Embodiment

Next, a modification of the first example embodiment of the present disclosure will be described in detail with reference to the drawings. Hereinafter, description of contents overlapping with the above description will be omitted to the extent that the description of the present example embodiment is not unclear. Similarly to the computer device illustrated in FIG. 2, each component in each example embodiment of the present disclosure can be achieved not only by hardware but also by a computer device or software based on program control.

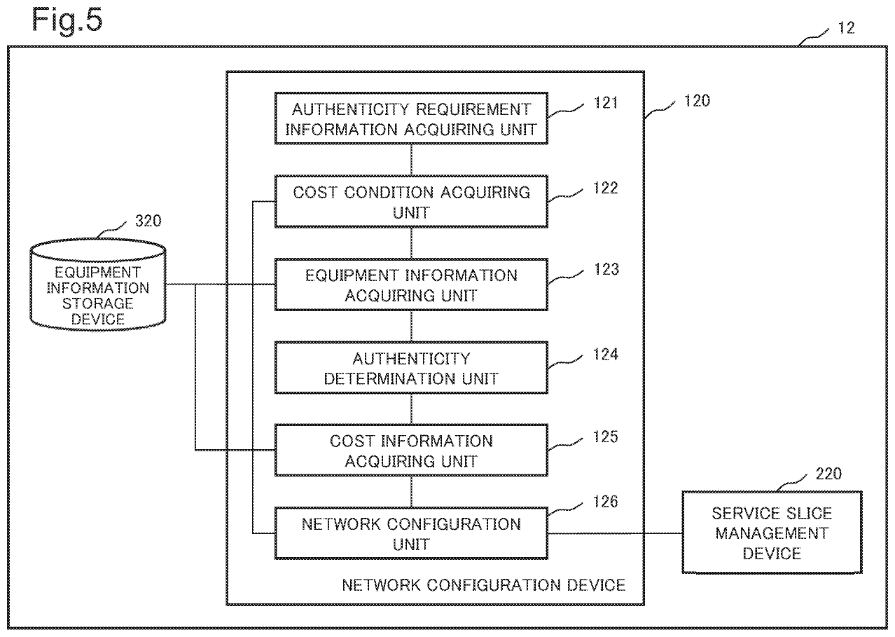

FIG. 5 is a block diagram illustrating a configuration of a network configuration device 120 according to the second example embodiment of the present disclosure. With reference to FIG. 5, the network configuration device 120 according to the second example embodiment will be described focusing on portions different from those of the network configuration device 100 according to the first example embodiment. In the second example embodiment, in a case where an authenticity requirement information acquiring unit 121 acquires information that authenticity is not necessary, a scene in which a virtual network is configured is assumed based on cost conditions of a communication service. The network configuration device 120 according to the second example embodiment includes an authenticity requirement information acquiring unit 121, a cost condition acquiring unit 122, an equipment information acquiring unit 123, an authenticity determination unit 124, a cost information acquiring unit 125, and a network configuration unit 126. That is, the second example embodiment is different from the first example embodiment in that the cost condition acquiring unit 122 and the cost information acquiring unit 125 are provided.

The present example embodiment is also different in that an equipment information storage device 320 stores cost information required for using a network equipment in addition to equipment information of the network equipment. The equipment information storage device 320 stores, as the cost information, for example, the cost of using each network equipment in a case where authenticity is secured and in a case where authenticity is not secured. Since the authenticity requirement information acquiring unit 121 is similar to the authenticity requirement information acquiring unit 101 in the first example embodiment, the description thereof is omitted.

The cost condition acquiring unit 122 is a means that acquires the cost condition of the communication service in a case where the information indicating that the authenticity of the communication service is not necessary is acquired from the authenticity requirement information acquiring unit 121. For example, the cost condition acquiring unit 122 acquires the authenticity requirement information by receiving an input of information regarding the cost condition from the input device 509. The cost condition is, for example, an upper limit of the cost borne by the user for the network equipment of the communication service. The cost condition acquiring unit 122 outputs information regarding the cost condition to the network configuration unit 126.

The equipment information acquiring unit 123 acquires equipment information in which a configuration and a risk regarding network equipment connected to a network are visualized. The method of acquiring the equipment information by the equipment information acquiring unit 123 is similar to the operation performed by the equipment information acquiring unit 102 of the first example embodiment.

The authenticity determination unit 124 determines the authenticity of the network equipment based on the equipment information acquired by the equipment information acquiring unit 123. The authenticity determination method by the authenticity determination unit 124 is similar to the operation performed by the authenticity determination unit 103 of the first example embodiment.

The cost information acquiring unit 125 is a means that acquires cost information required for using the network equipment relevant to the determination result of authenticity determined by the authenticity determination unit 124. In a case where the authenticity determination unit 124 determines that there is authenticity, the cost information acquiring unit 125 acquires the cost information of each network equipment in a case where authenticity is secured from the equipment information storage device 320. On the other hand, in a case where the authenticity determination unit 124 determines that there is no authenticity, the cost information acquiring unit 125 acquires the cost information of each network equipment in a case where the authenticity is not secured from the equipment information storage device 320. The cost information acquiring unit 125 outputs the acquired cost information of each network equipment to the network configuration unit 126.

The network configuration unit 126 configures a virtual network based on the cost information acquired by the cost information acquiring unit 125 so as to satisfy the cost condition acquired by the cost condition acquiring unit 122.

Here, a method of configuring a virtual network by the network configuration unit 126 will be described with a specific example. For example, it is assumed that the cost condition acquired by the cost condition acquiring unit 122 is 300. The number of network equipment connected to the network is five, and the cost information acquired by the cost information acquiring unit 125 is 100 for devices whose authenticity is secured and 50 for devices whose authenticity is not secured. For convenience of explanation, the cost information for each network equipment is the same, but may actually be different. The network configuration unit 126 selects the network equipment so that the total cost of the five pieces of network equipment does not exceed the cost condition of 300. In this case, in a case where one piece of equipment (100) whose authenticity is secured and four pieces of equipment (50×4) whose authenticity is not secured are selected, the cost condition 300 is not exceeded. Therefore, the network configuration unit 126 configures a virtual network so as to include one equipment whose authenticity is secured and four pieces of equipment whose authenticity is not secured.

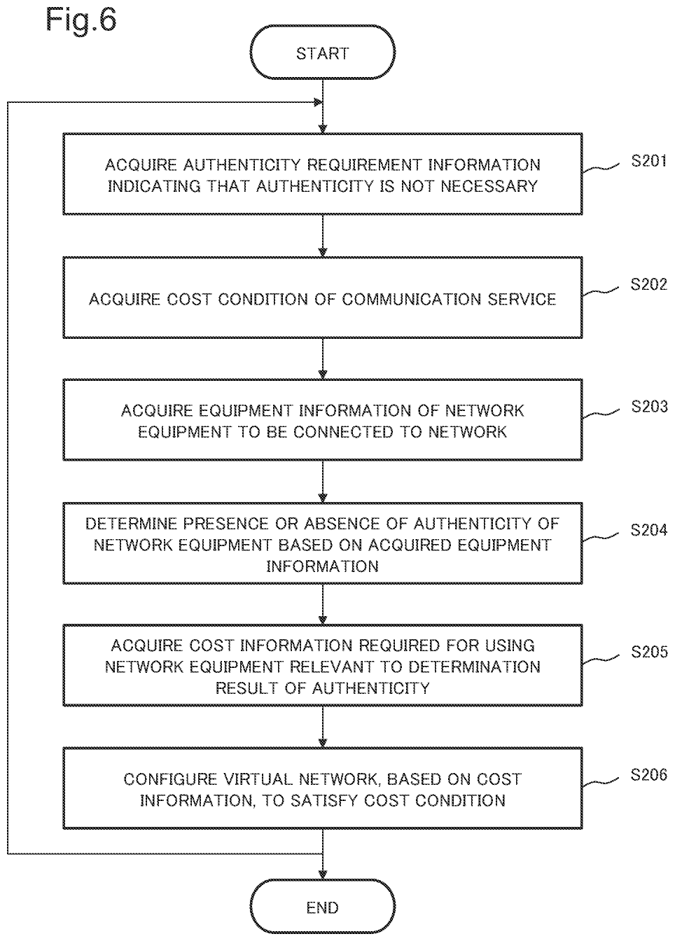

The operation of the network configuration device 110 configured as described above will be described with reference to the flowchart of FIG. 6.

FIG. 6 is a flowchart illustrating an outline of an operation of the network configuration device 110 according to the second example embodiment. The processing according to this flowchart may be executed based on program control by the processor described above.

As illustrated in FIG. 6, first, when the authenticity requirement information acquiring unit 121 acquires the authenticity requirement information indicating that authenticity is not necessary (step S201), the cost condition acquiring unit 122 acquires information regarding the cost condition of the communication service (step S202). Next, the equipment information acquiring unit 123 acquires equipment information of the network equipment connected to the network (step S203). Next, the authenticity determination unit 124 determines the authenticity of the network equipment based on the equipment information acquired by the equipment information acquiring unit 123 (step S204). Next, the cost information acquiring unit 125 acquires cost information required for using the network equipment relevant to the determination result of authenticity determined by the authenticity determination unit 124 (step S205). Finally, the network configuration unit 126 configures a virtual network based on the cost information acquired by the cost information acquiring unit 125 so as to satisfy the cost condition acquired by the cost condition acquiring unit 122 (step S206). When configuring a virtual network, the network configuration device 120 repeats a series of flows when acquiring the authenticity requirement information indicating that authenticity is not necessary by the authenticity requirement information acquiring unit 121. Thus, the network configuration device 120 terminates the operation of the network configuration.

In the present example embodiment, a virtual network is configured based on the cost information acquired by the cost information acquiring unit 125 so as to satisfy the cost condition acquired by the cost condition acquiring unit 122. As a result, the network configuration device 120 can configure a virtual network using, for example, equipment whose authenticity is secured within a range satisfying the cost condition. Therefore, it is possible to configure a virtual network while considering the cost of the communication service.

Although the present invention has been described with reference to each example embodiment, the present invention is not limited to the above example embodiments. Various modifications that can be understood by those of ordinary skill in the art can be made to the configuration and details of the present invention within the scope of the present invention.

For example, although the plurality of operations is described in order in the form of a flowchart, the order of description does not limit the order of executing the plurality of operations. Therefore, when each example embodiment is implemented, the order of the plurality of operations can be changed within a range that does not interfere with the content. In the present example embodiment, the network configuration unit 126 configures a virtual network based on the cost information acquired by the cost information acquiring unit 125 so as to satisfy the cost condition acquired by the cost condition acquiring unit 122. However, the network configuration unit 126 may configure a virtual network using network equipment so as to satisfy performance conditions such as a communication speed and power saving of a communication service in addition to cost conditions. In this case, the information about the performance of the network equipment is stored in, for example, the equipment information storage device 320. The network configuration device 120 acquires the information regarding the performance condition of the network equipment from an equipment information storage device 310. Furthermore, in each example embodiment, a means for allocating a communication function necessary for a communication service to a virtual network configured by a network configuration unit may be further included.

In the present example embodiment, in a case where the authenticity requirement information acquiring unit 121 acquires information that authenticity is not necessary, a scene in which a virtual network is configured based on cost conditions of a communication service is assumed. However, also in the present example embodiment, the authenticity requirement information acquiring unit 121 may acquire information regarding the degree of the requirement of authenticity. In this case, the cost condition acquiring unit 122 acquires the cost condition of the communication service regardless of the information acquired by the authenticity requirement information acquiring unit 121. The network configuration unit 126 configures a virtual network based on the cost information acquired by the cost information acquiring unit 125 so as to satisfy the cost condition acquired by the cost condition acquiring unit 122.

### REFERENCE SIGNS LIST

10, 11, 12 information system
100, 110, 120 network configuration device
101, 111, 121 authenticity requirement information acquiring unit
102, 112, 123 equipment information acquiring unit
103, 114, 124 authenticity determination unit
104, 115, 126 network configuration unit
113 risk score calculation unit
122 cost condition acquiring unit
125 cost information acquiring unit
200, 210, 220 service slice management device
300, 310, 320 equipment information storage device

What is claimed is:

1. A network configuration device comprising:
a memory storing instructions; and
at least one processor configured to execute the instructions to:
acquire authenticity requirement information related to requirement of authenticity with respect to a communication service;
acquire equipment information in which configuration and a risk related to network equipment to be connected to a physical network are visualized;
determine authenticity of the network equipment based on the acquired equipment information; and
configure a virtual network on the physical network based on the authenticity requirement information and a determination result of authenticity of the network equipment.

2. The network configuration device according to claim 1, wherein the equipment information acquired includes different types of configuration information, event information, and inspection information of the network equipment.

3. The network configuration device according to claim 1,
wherein the at least one processor is further configured to execute the instructions to:
calculate a risk score that is a degree of the authenticity, and
determine authenticity of the network equipment based on the calculated risk score.

4. The network configuration device according to claim 1, wherein the at least one processor is further configured to execute the instructions to:
in a case where information indicating that authenticity with respect to a communication service is necessary is acquired, configure the virtual network in such a way as to include only network equipment determined to have authenticity.

5. The network configuration device according to claim 1, wherein the at least one processor is further configured to execute the instructions to:
in a case where information that authenticity with respect to a communication service is not necessary is acquired, configure the virtual network in such a way as to include network equipment determined to have no authenticity.

6. The network configuration device according to claim 1, wherein the at least one processor is further configured to execute the instructions to:
acquire a cost condition of a communication service in a case where information indicating that authenticity of a communication service is not necessary is acquired;
acquire cost information required for using the network equipment relevant to the determination result of the determined authenticity, and
configure the virtual network based on the cost information in such a way as to satisfy the cost condition.

7. The network configuration device according to claim 1, wherein the at least one processor is further configured to execute the instructions to:
allocate, to the virtual network, a communication function of the network equipment constituting the virtual network.

8. An information system including:
a network configuration device;
a service slice management device that manages and controls the network configuration device; and
an equipment information storage device that stores equipment information in which a configuration and a risk regarding a network equipment connected to a physical network are visualized, wherein
the network configuration device comprising:
a memory storing instructions; and
at least one processor configured to execute the instructions to:
acquire authenticity requirement information related to requirement of authenticity with respect to a communication service;
acquire the equipment information from the equipment information storage device;
determine authenticity of the network equipment based on the acquired equipment information; and
configure a virtual network on the physical network based on the authenticity requirement information and a determination result of authenticity of the network equipment.

9. A network configuration method comprising:
acquiring authenticity requirement information related to requirement of authenticity with respect to a communication service;
acquiring equipment information in which configuration and a risk related to network equipment connected to a physical network are visualized;
determining authenticity of the network equipment based on the acquired equipment information; and
configuring a virtual network on the physical network based on the authenticity requirement information and a determination result of authenticity of the network equipment.

10. A non-transitory computer readable recording medium having stored therein a program causing a computer to execute:
acquiring authenticity requirement information related to requirement of authenticity with respect to a communication service;
acquiring equipment information in which configuration and a risk related to network equipment connected to a physical network are visualized;
determining authenticity of the network equipment based on the acquired equipment information; and
configuring a virtual network on the physical network based on the authenticity requirement information and a determination result of authenticity of the network equipment.
